(19) United States
(12) Patent Application Publication
(10) Pub. No.: US 2012/0035897 A1
(43) Pub. Date: Feb. 9, 2012

(54) Solar Energy Computation and Planning System

(76) Inventor: Kevin Bell, Salt Lake City, UT (US)

(21) Appl. No.: 13/198,611

(22) Filed: Aug. 4, 2011

Related U.S. Application Data
(60) Provisional application No. 61/370,941, filed on Aug. 5, 2010.

(51) Int. Cl. G06F 7/60

(52) U.S. Cl. 703/2

(57) ABSTRACT

A solar information system may take terrain data with solar and atmospheric parameters to compute a solar dataset which may then be used by a service to provide derivative datasets, such as heat maps, solar panel advice or interactive web services.

### RELATED APPLICATIONS

The present application claims the benefit of U.S. Provisional Application Ser. No. 61/370,941, filed Aug. 5, 2010, the entirety of which is incorporated herein by reference.

### THE FIELD OF THE INVENTION

The present invention relates to calculating and utilizing solar energy. More specifically, the present invention relates to an efficient and accurate method for calculating the available solar energy for specific areas within an actual geographic location.

### BACKGROUND

Renewable and/or Green energy are gaining traction as energy sources. Unfortunately, renewable and green energy can be expensive to harvest and dependant on environmental factors and changes. In many cases, it can be difficult to plan and implement systems for harvesting renewable energy.

One type of green energy is solar energy. While solar energy is a desirable source of energy, it can be difficult to harvest as it is quite variable based on the season, geographic location, and the particular topography of a location. Total solar energy is based in the amount of light that reaches a location over time. Many different environmental factors may affect the available amount of light. Unfortunately, miscalculation or estimation of the amount of light available may result in magnitudes of difference of actual available light. Thus, miscalculations may result in a lower energy production or in a wasted investment.

Further, the amount of data available and necessary for calculating the amount of available solar power is often monstrously large-large to the point of being beyond the memory and processing capacity of a computer to compute the dataset at once. Thus, the accurate estimation of solar energy available at a location is a complex task that can take a large amount of computing power a long time to complete. In determining where to best utilize solar energy it is typically desirable to analyze and calculate solar data for a large area such as a city or a large plot of land. It is also desirable to obtain detailed and accurate information in order to best utilize solar power. It will be easily appreciated that trying to obtain detailed calculated solar information for a large area quickly exceeds the ability to calculate the desired information.

Current systems for making solar calculations may use different schools of thought. These schools of thought include simple estimation or a brute force and time-consuming computation. In some cases, the system uses simplistic assumptions, such as assuming a flat terrain and a one-size-fits all calculation, that allows for a quick estimation of solar energy, but may give bad data if the assumption is wrong. In the case of flat terrain assumption, a small building which is next to a large building may be shadowed for a significant period of time, making the assumption and resulting calculations clearly wrong.

Attempts to accurately calculate available solar power through brute force processing of the available terrain data have generally failed as the tremendous amount of data required for calculating an entire plot of land overwhelms available computational power. As mentioned, it is rarely desirable to analyze a single small section of land. More commonly, a city desires to analyze the entire city area or a company desires to analyze a large area of available land. The inability to process the entire data set for the desired section of land at once requires dividing the data into sections for calculation. Many problems arise from such a sectional calculation, however. If a border around a desired section is chosen at random, such as choosing a border of each surrounding section of land and processing these sections along with a desired section of land, the resulting calculation may be inaccurate or unnecessarily large. If too large of a border is selected, the calculation times may be unnecessarily large. If too small of a border is chosen, the results may be inaccurate, as adjacent land and structures cast shadows or reflections onto surrounding land and affect the available solar energy. Attempts to simply process the topographical data for smaller cities by brute force have taken several months or longer of continuous computer processing time to achieve the results.

Thus there is a need for a better way to determine the solar energy available for use with green energy planning. In particular, it can be seen how there is a need for a method of processing the geographic and topographical information for large areas of land in order to determine availability of solar energy for particular locations within the area. There is a need for a method of processing such data which allows for the use of detailed topographical information (including detailed information about trees, buildings and the like) at a high resolution for calculating available solar power while still achieving accurate results and reasonable computational times.

### SUMMARY

Embodiments of the present invention provide an improved solar energy computation and advising system. Some embodiments of the present invention take detailed topographical information for an area such as a city and calculate available solar energy for detailed locations within the area.

According to one aspect of the invention, a large three dimensional dataset of the topography of a desired area is trimmed into representative height features, tiled into manageable pieces, with individualized buffers for each tile based on the solar effect of surrounding tiles, which may include height and reflection. This processing of the dataset reduces the redundant computation of tiles while providing a more accurate representation at the boundary of each tile.

According to another aspect of the invention, the buffers are re-defined for different times of the year depending on the solar angle and the effects of surrounding features outside of each tile. This allows the system to tailor each determination to only the solar effects that could provide a significant influence on a tile during a specific time of year.

These and other aspects of the present invention are realized in a solar energy computation and advising system as shown and described in the following figures and related description.

### BRIEF DESCRIPTION OF THE DRAWINGS

Various embodiments of the present invention are shown and described in reference to the numbered drawings wherein:

FIG. 1 shows an overview diagram of a solar energy computation and advising system;

FIG. 2 shows a diagram of interconnected modules of a solar energy processing system;

FIG. 3 shows a diagram for understanding LIDAR data;

FIG. 4 shows a resulting dataset of location and height coordinates;

FIG. 5 shows a diagram of a tiled selection of a dataset with height features;

FIG. 6 shows a diagram of a tiled selection upon which a height location determination has been performed;

FIG. 7 shows a diagram of a target tile adjacent comparison being performed;

FIG. 8 shows a diagram of a buffer size determination performed on a target tile;

FIG. 9 shows a uniform final buffer size determination;

FIG. 10 shows a varied square buffer size determination;

FIG. 11 shows a surface of influence for irregular buffer size determinations;

FIG. 12 shows an irregular buffer size determination with exemplary features;

FIG. 13 shows a diagram of selected tiles with buffers;

FIG. 14 shows the resulting valid data within selected buffers;

FIG. 15 shows an example of a dataset with shadow-mapping at a time of day;

FIG. 16 shows an example of a dataset with shadow-mapping at a different time of day;

FIG. 17 shows an example of a system providing derivative mapping and advice based in the solar energy mapping;

FIG. 18 shows an example of a solar heat-map derived from the solar energy data; and

FIG. 19 shows an example of available solar energy upon a stadium in Salt Lake City, Utah.

It will be appreciated that the drawings are illustrative and not limiting of the scope of the invention which is defined by the appended claims. The embodiments shown accomplish various aspects and functionality of the invention. It is appreciated that it is not possible to clearly show each element and aspect of the invention in a single figure, and as such, multiple figures are presented to separately illustrate the various details of embodiments of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

Many of the functional units described in this specification have been labeled as modules, in order to more particularly emphasize their implementation independence. Modules are at least partially implemented in hardware, in one form or another. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented using software, stored on a physical storage device (e.g., a computer readable storage medium), for execution by various types of processors. Examples of a computer-readable storage medium include, but are not limited to, a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several storage or memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more physical devices which are referred to herein as computer readable media and/or electronic data storage devices.

In some embodiments, the software portions are stored in a non-transitory state such that the software portions, or representations thereof, persist in the same physical location for a period of time. Additionally, in some embodiments the software portions are stored on one or more non-transitory storage devices, which include hardware elements capable of storing non-transitory states and/or signals representative of the software portions, even though other portions of the non-transitory storage devices may be capable of altering and/or transmitting the signals. One example of a non-transitory storage device includes a read-only memory (ROM) which can store signals and/or states representative of the software portions for a period of time. However, the ability to store the signals and/or states is not diminished by further functionality of transmitting signals that are the same as or representative of the stored signals and/or states. For example, a processor may access the ROM to obtain signals that are representative of the stored signals and/or states in order to execute the corresponding software instructions.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any physical form capable of storing machine-readable instructions, at least for a time in a non-transient state, on a digital processing apparatus. A computer readable medium may be embodied by a compact disk, digital-video disk, a magnetic tape, a Bernoulli drive, a magnetic disk, flash memory, integrated circuits, or other digital processing apparatus memory device.

Furthermore, the described features, structures, or characteristics of embodiments of the invention may be combined in any suitable manner in one or more embodiments. In the following description, numerous specific details are provided, such as examples of programming, software modules (stored on a physical device), user selections, network transactions, database queries, database structures, hardware modules, hardware circuits, hardware chips, etc., to provide a thorough understanding of embodiments of the invention. One skilled in the relevant art will recognize, however, that embodiments of the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

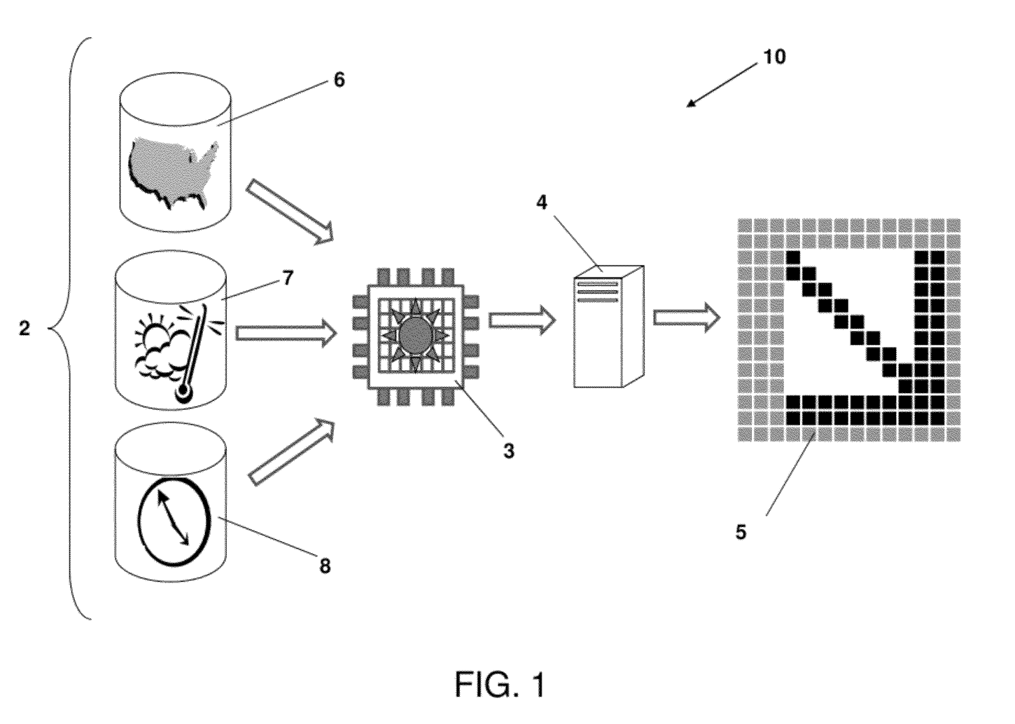

Turning now to FIG. 1, an overview diagram of a solar energy computation and advising system 10 is shown. The system 10 may take in databases 2 containing solar information and parameters, process the data to obtain solar energy datasets, and then use the solar energy datasets to create various derivative datasets and charts including solar heat maps, interactive web services or recommendations for solar panel placement.

More specifically, various databases 2 related to solar energy are transferred to a solar energy processing system 3. The solar energy processing system 3 prepares the data received for processing and outputs solar data sets, which may include duration of solar energy and watt-hour of solar energy. The output may then be sent to a service 4, which may transform the data sets into derivative data sets 5. The service 4 may be interactive with users or prepare a fixed end product.

The various databases 2 may include mapping data 6, atmospheric parameters 7, and solar parameters 8. The databases 2 may be retrieved from external sources, such as a geographic information system (GIS), or be prepared internally, such as specially commissioned light detection and ranging (LIDAR) data. In one embodiment, the input data includes LIDAR data, a relevant time span, diffuse proportion of sunlight, atmospheric transmittivity, and a latitude/longitude correlation for the LIDAR data.

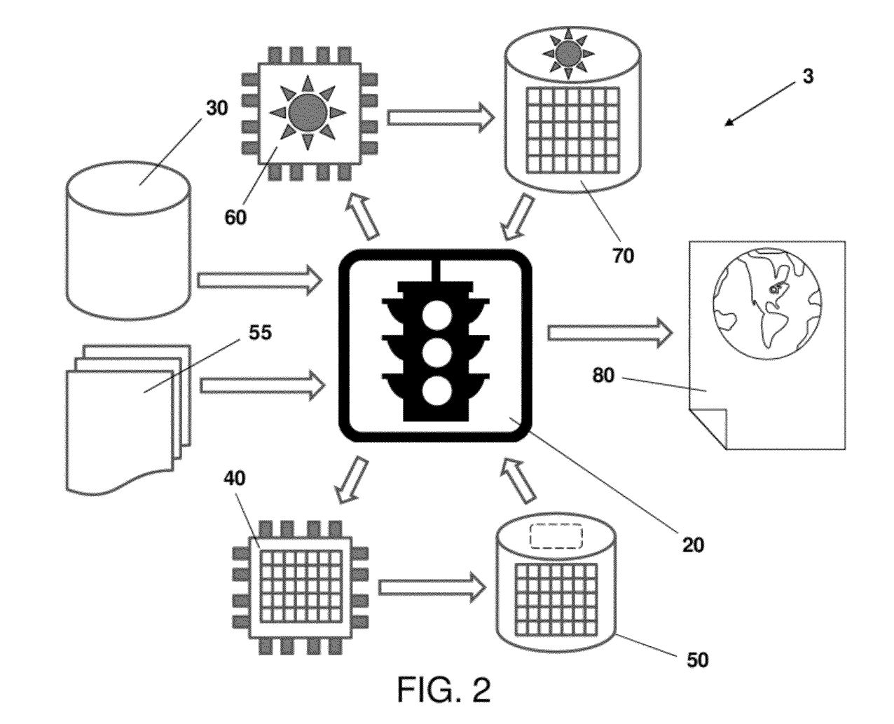

Turning now to FIG. 2, a diagram of interconnected modules of a solar energy processing system 3 from FIG. 1 is shown. As the data is generally sufficiently large as to not fit within the memory or processing constraints of most computing systems, the data is reduced to a manageable computing level, while having reliable results. This may be accomplished by breaking apart the data into tiles, adding a buffer that represents neighboring tiles that have influence on that tile, computing the result of the buffered tile, discarding the buffer from the resulting output of the tile and stitching back together all of the computed tiles into a final data set, chart, or the like.

In the embodiment shown in FIG. 2, a control module 20, such as a software module operating in a computer processor, requests terrain data from a database 30. The terrain data is sent to a data preparation module 40 to be cleaned, divided into smaller geographic regions referred to as tiles, and buffered. In some cases, the data preparation module 40 may be further divided into a cleaning module, tiling module and a buffering module (not shown). The resulting dataset may then be stored in a source database 50. The control module 20 may then request tiles and corresponding buffers from the source database 50. Seasonal, geographical and atmospheric data information 55 with the data from the source database 50 may then be sent to the solar computational module 60. The solar computational module 60 may then complete the solar energy computation and present the tile results to the output database 70. The output database 70 may then be used to provide solar maps, recommendations or other solar applications by way of the application services module 80.

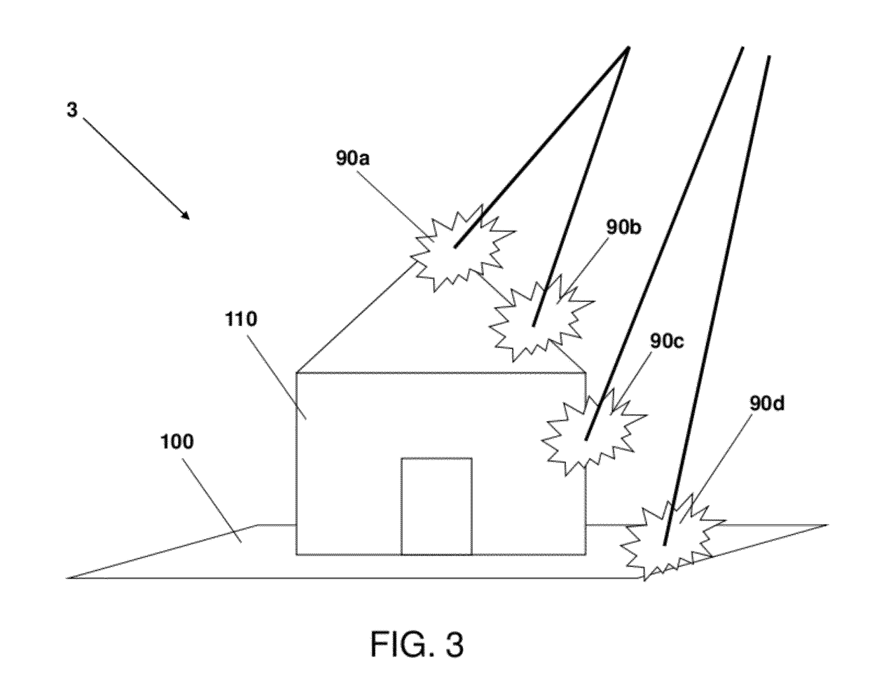

Cleaning the terrain data reduces the computational complexity and may aid in the solar estimation accuracy and usefulness. An example of terrain data is shown in FIG. 3, which represents LIDAR data. An example of a four strike datapoint may be seen in the laser strikes 90a, 90b, 90c, 90d within the unit area 100. The LIDAR data may be designated by groups of longitude (x-value), latitude (y-value) and a series of height values (z-values). In other cases, the LIDAR data may be a series of x,y,z values. As strikes 90a, 90b, 90c, 90d may be encountered in any order, the actual height of an object 110 within the unit area 100 may not be obvious. For instance, a set of LIDAR strikes may occur on a tree by striking on a leaf, branch, tree trunk and ground in the unit area. Thus, selection of a height value may affect the accuracy of the solar data, when the dataset gives large variances in z coordinates for the same x and y coordinates. The representation of LIDAR strikes is shown in an enlarged area for purposes of discussion. Often, the LIDAR data may have data points about three feet apart, providing a more detailed depiction of the desired terrain.

Several calculations may be used to select a height value. A simple calculation may be to accept the highest strike. A median value may be chosen. An average value may be chosen. The average value may refer to any statistical measure commonly understood as a form of describing centrality within a data set. One example of an average value is an arithmetic mean. The median is another example of an average value. A statistical analysis may be used to eliminate an outlier from the other data points. In one embodiment, the highest strike 90a is chosen as it represents the maximum solar influence of the unit area 100. By choosing the highest strike 90a, the resulting calculation may give the most conservative result. In other words, the highest strike 90a may accentuate any solar influence of a unit area 100. For instance, if the highest strike was on a leaf, then selecting the highest strike (the leaf) is more likely representative of the shadow that the tree would cast. In other cases, it may be useful to examine the neighboring unit areas or neighboring z strike values to determine if a z-value is unreasonable.

Further cleaning of the data may be done in altering the selected values from the strike data. Frequently, the LIDAR height values include decimal or fractional portions. In some cases it may simplify the calculation if the fractional portion of the numerical height is removed through truncation or rounding to an integer value or conversion to a smaller measurement (such as inches or centimeters) and truncation to an integer value. In some cases, the selected values may further be normalized such that a selected z-value becomes zero. In one embodiment, the global minimum of the overall area being analyzed is chosen to be zero, and the original height value from the global minimum is subtracted from each height value to normalize the data set.

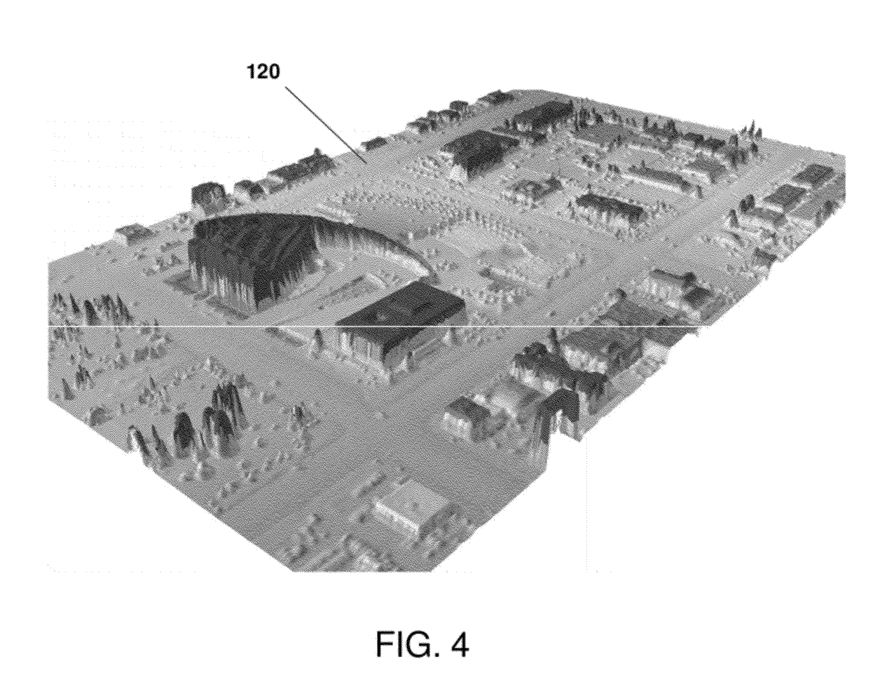

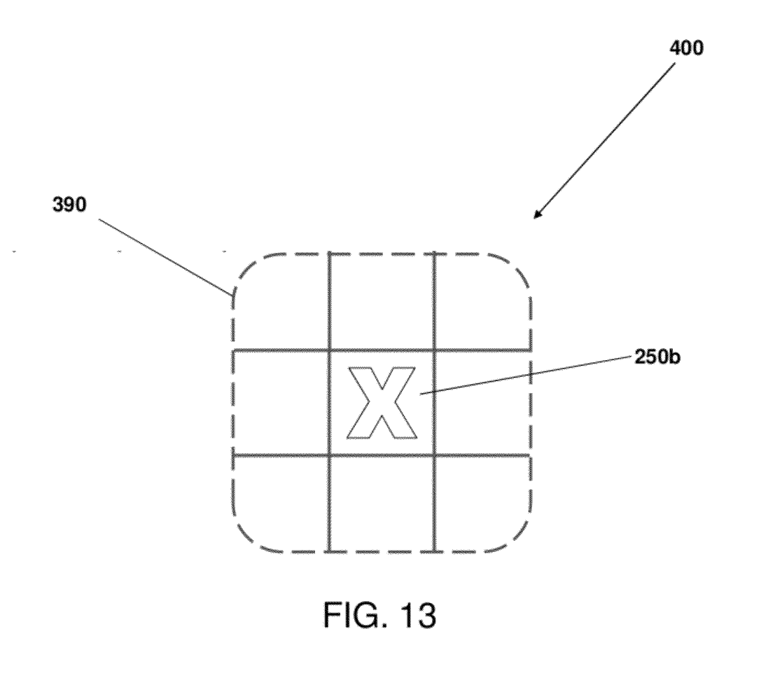

Turning now to FIG. 4, a three dimensional image 120 of a few city blocks resulting from a cleaned dataset of location and height coordinates as has been discussed is shown. Once the LIDAR data has been cleaned, the resulting dataset contains a representation of the heights over a geographic area. A three dimensional representation 120 of a resulting dataset is shown in FIG. 4. As the original data is a collection of points, assumptions may be made to convert the collection of points to a surface. In FIG. 4, extrusion of the points from a flat surface was chosen. However, other methods may be chosen, including other polygon surface, vertex, centroid or point assumptions or averages. The surface calculations may also be completed during the solar analysis discussed in FIG. 13.

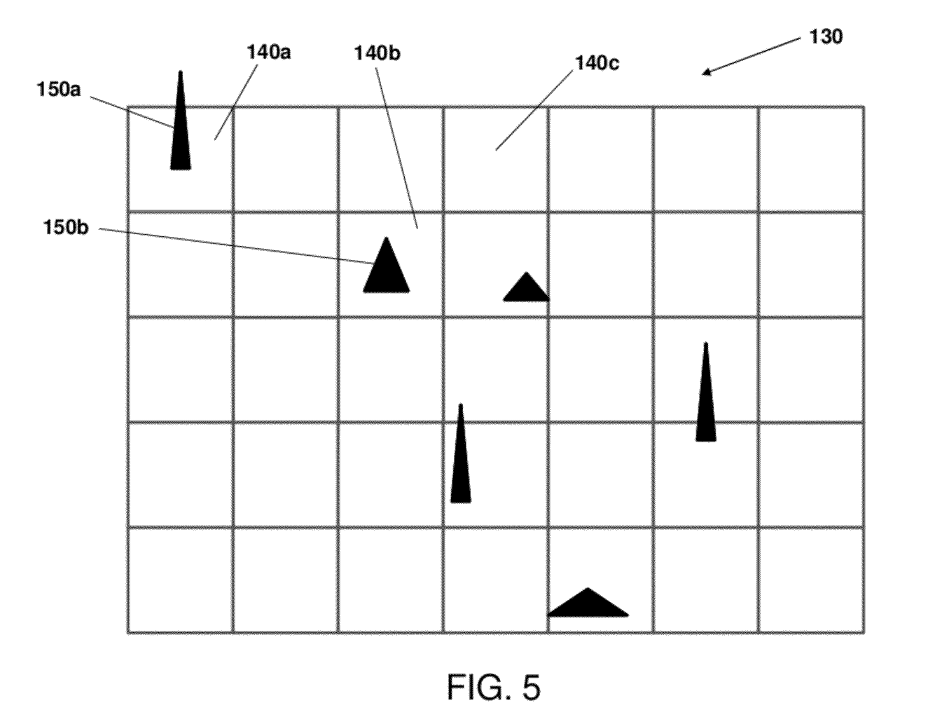

In FIGS. 5-12 and after cleaning, the dataset is broken into tiles and a buffer around the tiles is chosen according to the influence of the other tiles upon the tile of interest. As each tile receives a buffer only substantial enough to enable the reasonable calculation of solar energy, the amount of computing work may be reduced to allow for a faster processing of the entire dataset. The buffer may be determined by the shadow cast by neighboring tiles' features into the tile of interest.

Turning now to FIG. 5, once the terrain dataset is cleaned, the cleaned dataset 130 may be tiled and reviewed for features such as tall objects referred to as height features which influence the available solar power. FIG. 5 shows a diagram of a tiled selection of a cleaned dataset 130 with height features. The cleaned dataset 130 may be divided into tiles (such as 140a, 140b, 140c, etc.). Each tile (such as 140a, 140b, 140c) may have a largest feature (such as 150a, 150b). In one embodiment, the largest feature may be defined in different ways, including the largest z-value in the dataset, or the largest difference between the max z-value and minimum z-value.

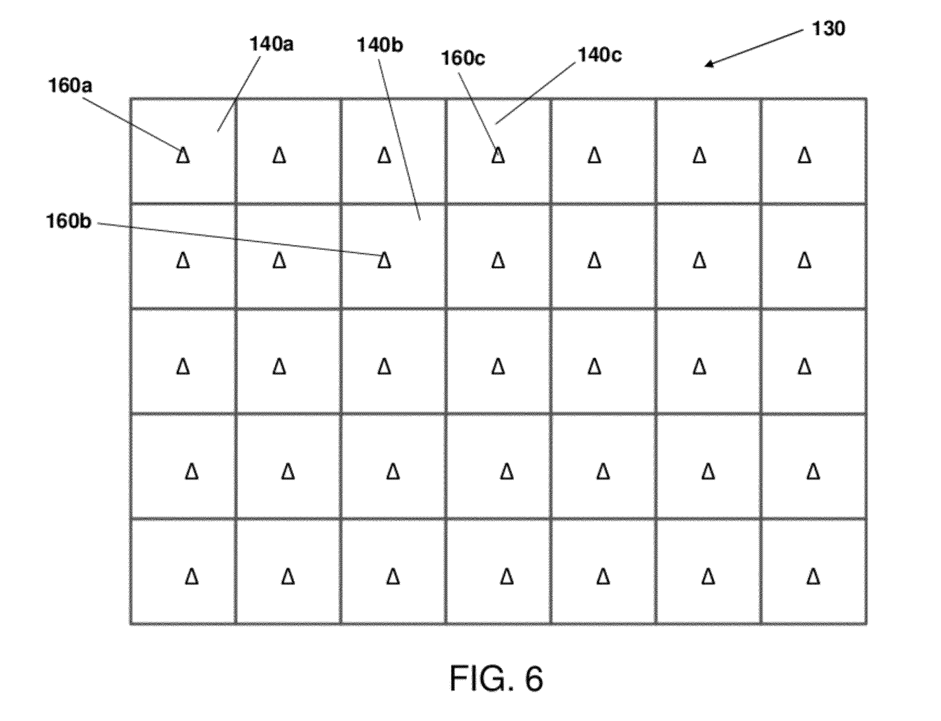

The dividing of the dataset 130 into tiles may be simplistic or algorithmic. In a simplistic choice, a standard tile size is chosen. In one embodiment, each tile is 1000 feet (or any other length) per side. In an algorithmic choice, the tile size is chosen by the features within the dataset. In one algorithmic embodiment, the tile size is chosen to be sufficiently larger than the height of the largest feature in the dataset. It appears that the larger the tiles, the smaller the buffer around the tile will be required. Thus, it may be useful to select a division for tiling that will allow for processing of the tile and buffer area within the limits of computer memory and processing power while using a division size that will reduce the buffer required. Determining the size of the buffer will be explained in conjunction with FIGS. 6-8.

For example, in Salt Lake City, Utah, a buffer size of 1000 feet per side may be appropriate. Few features (other than the mountains) rise to 1000 feet difference between the ground and the peak (the tallest building is believed to be about 422 feet). Thus the buffer size for most of the city (i.e., away from the mountains) should be less than one tile.

Turning now to FIG. 6, a diagram of tiled selection upon which a height location determination has been performed is shown in preparation for determining buffer sizes. Once the tiles (such as 140a, 140b, 140c) have been determined, the system 3 may then determine a maximum height (max z-value) and minimum height (min z-value) for each cell. Each set of values may be stored as associated with the cell, shown as a Δ (delta) in 160a, 160b, 160c. In one embodiment, the z-values are normalized, and therefore the minimum z-value need not be calculated and assumed to be zero. These stored z-values may then be used to determine buffer sizes by comparing neighboring tiles.

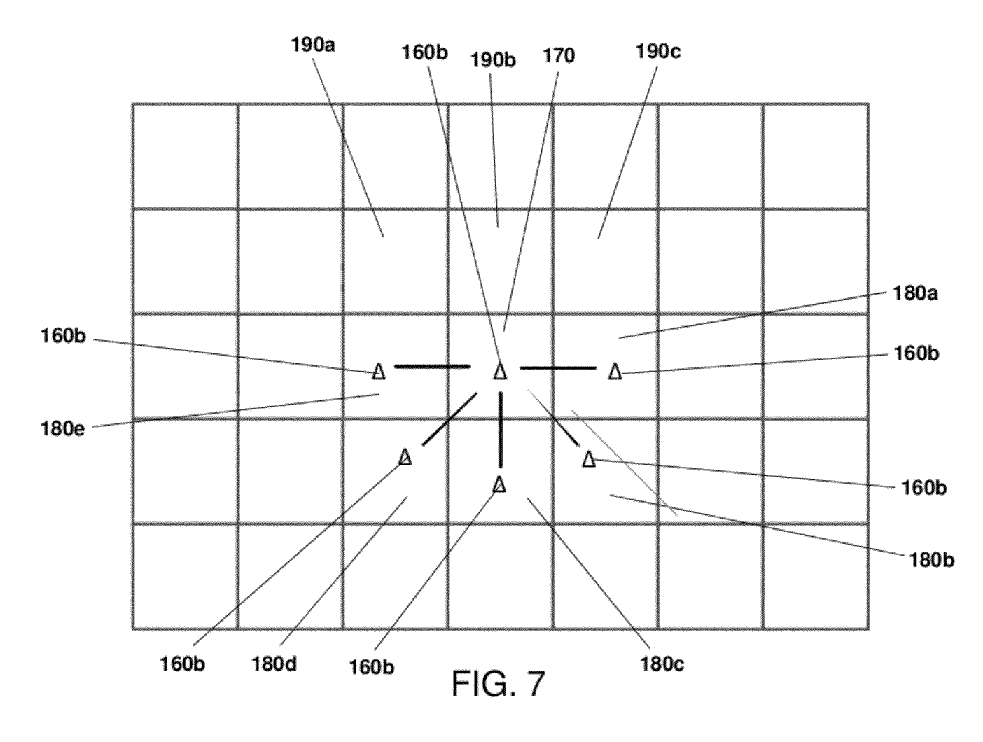

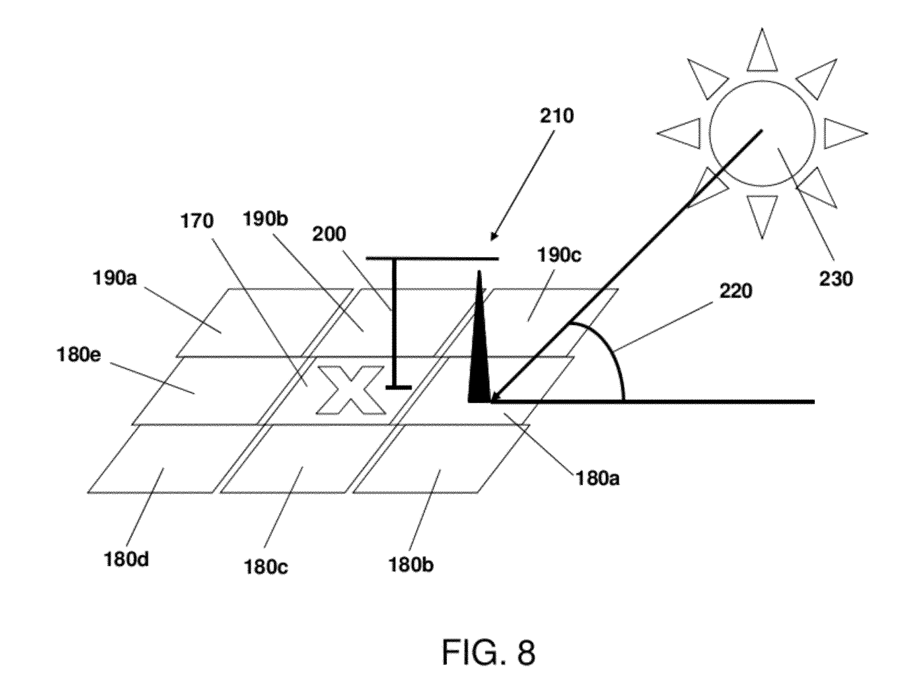

In FIG. 7, the selected tile 170 is compared against the surrounding tiles 180a, 180b, 180c, 180d, 180e in preparation for determining buffer sizes. In one embodiment that results in a uniform buffer, the comparison includes comparing the maximum of the bordering tiles and selecting the adjacent tile with the maximum z value contained within the tile. This maximum z value may then be used to determine the uniform buffer size as shown in FIG. 8. However, it should be noted that if the tile-size is not sufficiently large (i.e. large in comparison to the height of the objects within the tile), it may be advantageous to include a larger number of tiles than just the tiles immediately adjacent.

In the embodiment described above, it should be noted that the northern tiles 190a, 190b, 190c have minimal influence on the solar energy within the selected tile 170 and therefore may be omitted from the calculation. However, there may be legitimate reasons to include the northern tiles 190a, 190b, 190c in some calculations (such as in the southern hemisphere or where there may be significant reflected sunlight from objects such as buildings in the tiles) and/or exclude other tiles. It is thus appreciated that knowledge of the geographic area being analyzed can allow a person to exclude buffer data from calculation and optimize the buffer size where used to significantly reduce the time and computer power necessary for calculating the available solar potential in a desired tile or geographic area.

Turning now to FIG. 8, a diagram of a buffer size determination performed on a target tile is shown. The buffer distance may equal the difference 200 in elevation between the minimum of the selected tile 170 and the maximum z height 210 of the neighboring tiles 180a, 180b, 180c, 180d, 180e, divided by the tangent of the sun angle 220. In the embodiment shown, only the Southern Hemisphere tiles 180a, 180b, 180c, 180d, 180e (as opposed to the Northern tiles 190a, 190b, 190c) are used because it was noted that, in the example of Salt Lake City, the northern tiles had minimal influence from the sun on the selected tile 170. However, there may be legitimate reasons to include the northern tiles 190a, 190b, 190c depending on the geography, location, time of year and/or sun angle.

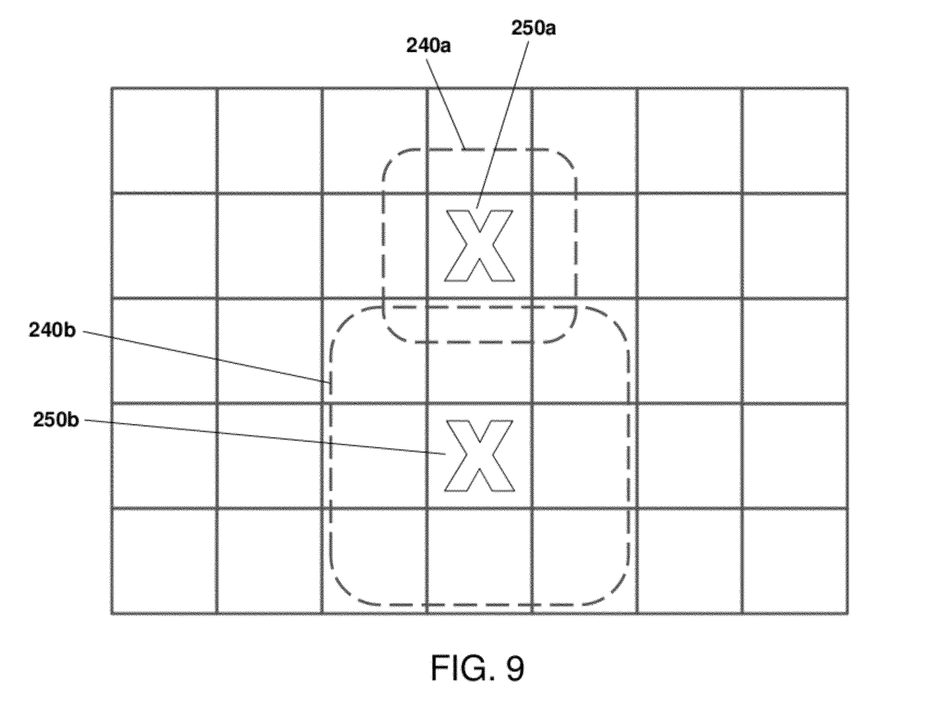

Turning now to FIG. 9, a uniform final buffer size determination is shown. When using a maximum z-value from the neighboring tiles, a buffer 240a, 240b will be applied uniformly around a buffered tile 250a, 250b. The larger the difference between the z-value minimum of the selected tile and the z-value maximum of the neighboring tiles, the larger the buffer. Thus a small difference may result in a small buffer 240a, while a large difference may result in a large buffer 240b. This calculation to determine an appropriate buffer size yields a buffer which is sufficiently large to adequately account for the effect of objects in neighboring tiles without using a buffer which is overly large and unnecessarily adds to the computation time.

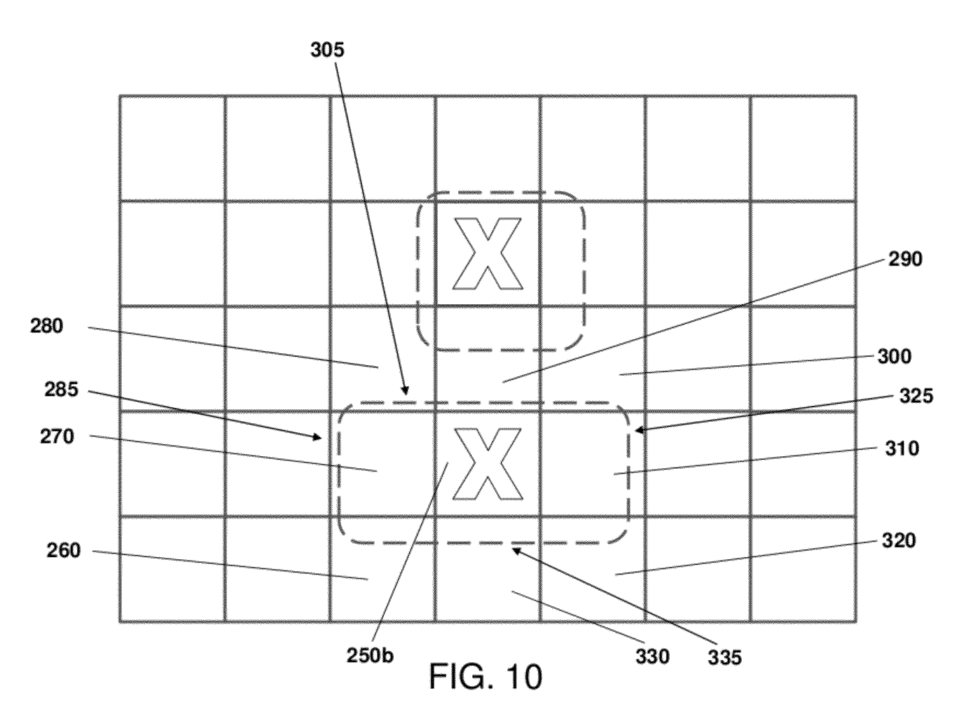

Turning now to FIG. 10, a varied rectangle buffer size determination is shown. In some cases, it may be more efficient to use a more complex buffer calculation and thereby further reduce the amount of solar energy calculation. Thus it may be useful to choose an individual buffer size for each side of the target tiles, or for each surrounding tile. In this case, the z-value of the western tiles 260, 270, 280 may be compared and the largest z-value may be used in the buffer computation of FIG. 8 to determine the western buffer 285 size. Similarly, the z-value of the northern tiles 280, 290, 300 may be compared and the largest z-value may be used in the buffer computation of FIG. 8 to determine the northern buffer 305 size. In the same way the eastern tiles 300, 310, 320 and southern tiles 320, 330, 260 examined and an appropriate buffer 325, 335 size may be computed. Thus, the computational complexity may be reduced from the large uniform buffer of FIG. 9 to a smaller rectangle in FIG. 10 with more pre-processing.

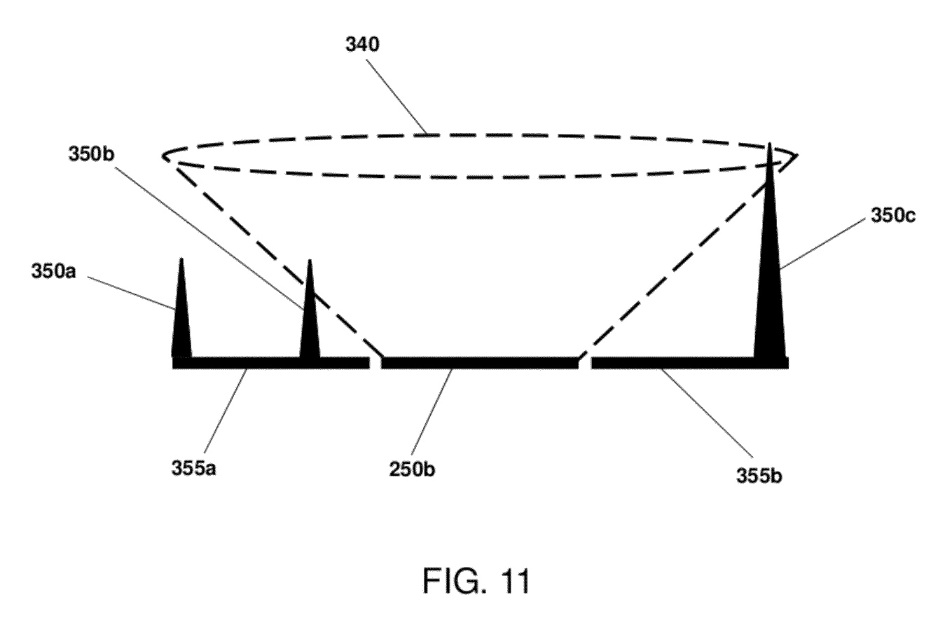

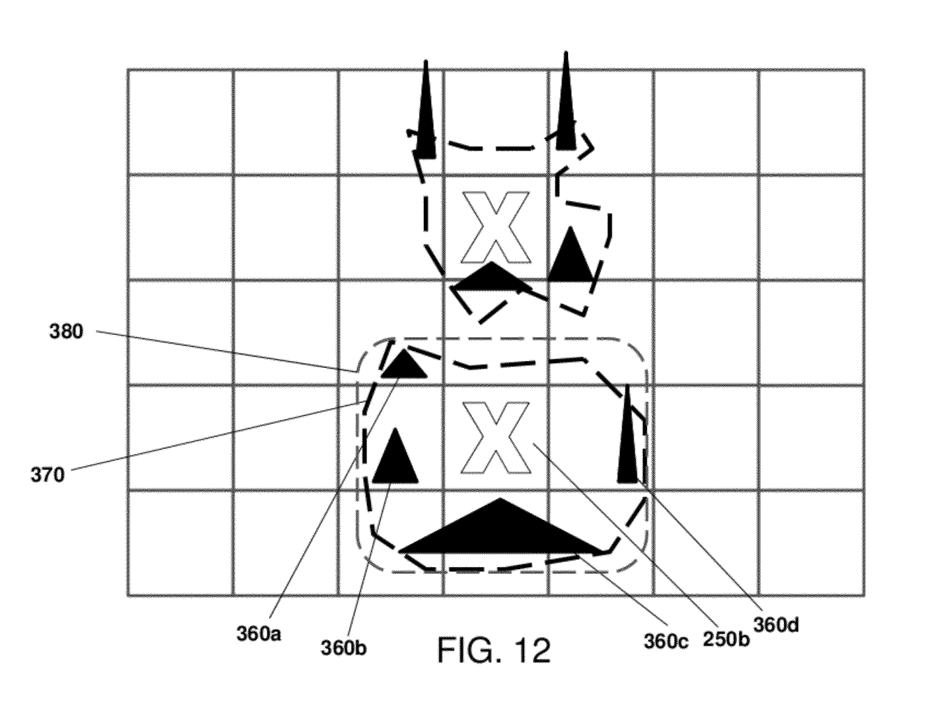

In FIGS. 11 and 12, an irregular buffer size is computed and shown to further reduce the required dataset. In some cases, where the solar calculating software requires a square dataset (or a dataset having another canonical shape), the unused space may be set to a minimum value to reduce the complexity of the calculation (see FIG. 12 and the associated description below). Additional space which, when added to irregular buffer size, would result in square or rectangular size.

Turning now to FIG. 11, a surface of influence 340 is shown in relation to terrain features 350a, 350b, 350c. In some cases, it may be worthwhile to reduce the buffer size further through more pre-processing. Using the calculation from FIG. 8, a height to distance ratio may be computed that results in a surface 340 of influence around the buffered tile 250b. The surface 340 defines the minimum height by which a terrain feature 350a, 350b, 350c must obtain to influence the buffered tile 250b from a neighboring tile 355a, 355b. Based on the height to distance ratio, the size of the surface 340 depends on the height of the surface 340. For example, a surface 340 at a lower height (i.e., closer to the terrain level) would be smaller than a surface 340 at a higher height. In FIG. 11, this variation of the size of the surface 340 is illustrated by an approximately conical volume, which shows a range of sizes relative to different heights. In one embodiment, any terrain feature which intercepts any of the potential surfaces 340 within the volume will result in an influence on the buffered tile 250b. Conversely, any terrain feature which does not intercept any of the potential surfaces 340 within the volume will not influence the buffered tile 250b. The surface 340 may be skewed due to lesser influence by northern tiles (as may be the case in Salt Lake City). However, a distance from the buffered tile assumption may be appropriate to reduce the processing complexity. Features equidistant from the tile may be compared against a similar height requirement.

If a terrain feature has a z-value greater than the z-value at the surface (terrain features 350b and 350c), the feature may be included in the buffer. If the terrain feature does not exceed the surface z-value (terrain feature 350a), the feature may not be included in the buffer. In other words, terrain features which have a height that extends into the volume corresponding to the height to distance ration of the surface of influence 340 will influence the buffer, while other terrain features will not influence the buffer.

Turning now to FIG. 12, an irregular buffer size determination with exemplary features 360a, 360b, 360c, 360d is shown. This buffer may be achieved by determining which terrain features are tall enough based on their proximity to the selected tile to affect the sunlight in the selected tile. After pre-processing, the irregular buffer 370 may have an irregular form. In some cases, the solar calculation algorithm may require a rectangular buffered tile 380, such that a bounding algorithm should be run on the irregular buffer 370 to result in a rectangular buffered tile 380. In other cases, it may be advantageous to set the area outside the irregular buffer to a rectangular or irregular shaped minimum value to ease the calculation.

As shown in FIGS. 13-16, once the buffer is determined, the solar analysis may be performed on the buffered tile. Once the analysis of solar power striking the areas within the target tile is complete, the analysis data for the buffered portion of the output may be discarded and the output area corresponding to the original tile may be stitched back together with the information from other target tiles to form the complete output dataset.

Turning now to FIG. 13, a diagram of selected tiles with buffers is shown. Once the buffer 390 has been selected around the buffered tile 250b, the processing tile 400 may be trimmed to the buffer 390. The processing tile 400 may then be sent to a solar computational module such as ArcGIS Desktop 10.0, Spatial Analyst, Solar Radiation Toolset from ERSI at 380 New York Street, Redlands, Calif. 92373-8100.

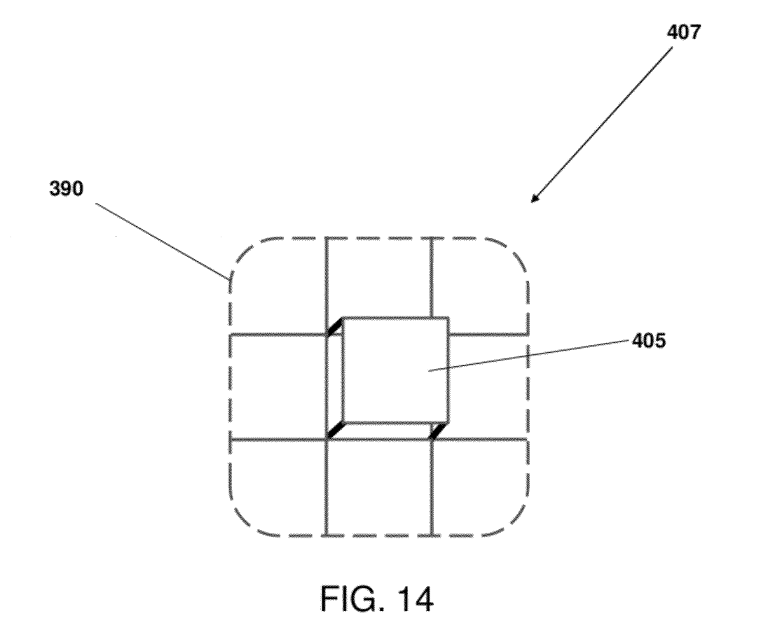

Once the solar computational module's calculation is complete, the output tile 407 related to the buffered tile 250b is trimmed as shown in FIG. 14. The trimmed output tile 405 of the buffered tile 250b is then stored, while the extraneous data of the output tile 407 may be disposed. Each trimmed output tile 405 may then be stitched back together to form an output dataset representing the solar data relating to the original input geography. This output dataset may include duration of solar energy and watt-hour of solar energy.

The output dataset may then be used by a service, such as a web-service, to compute solar heat maps, advice on solar panel placement, advice/predictions on plant/structure placement for influence on the reduction of heat to a building, or other solar energy maps, advice or transformations of the output.

It should be noted that the buffer calculations may be repeated for different times of the year, as the solar angle (the angle of the sun relative to the specific location being analyzed) changes. In one embodiment, the calculations are repeated for each month of the year. The output dataset is thus stored for each month of the year, and may be combined in a yearly report or requested for certain times of the year that are found to be concerning.

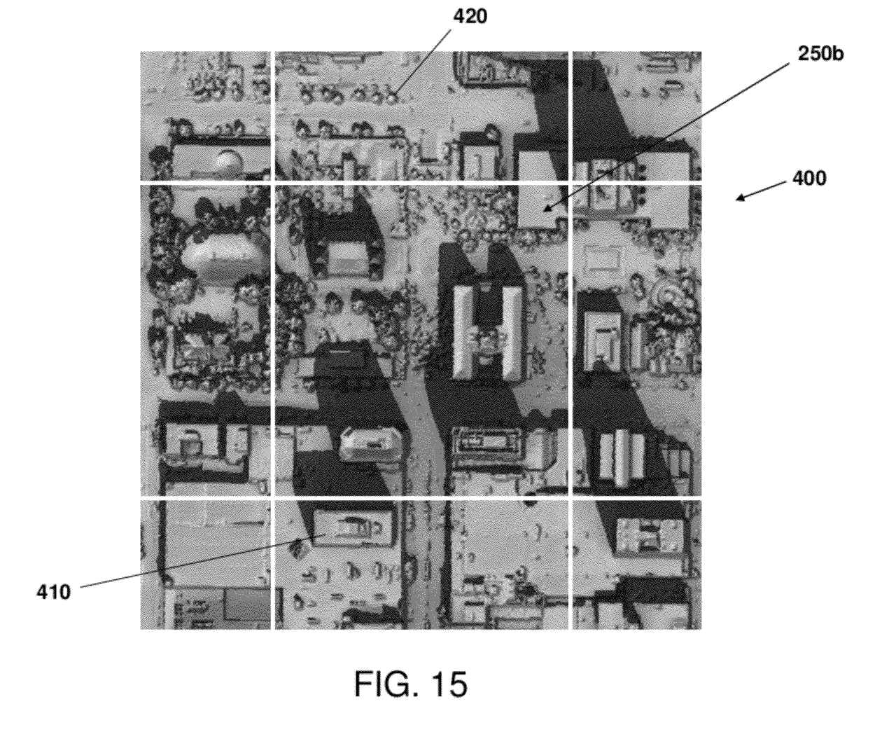

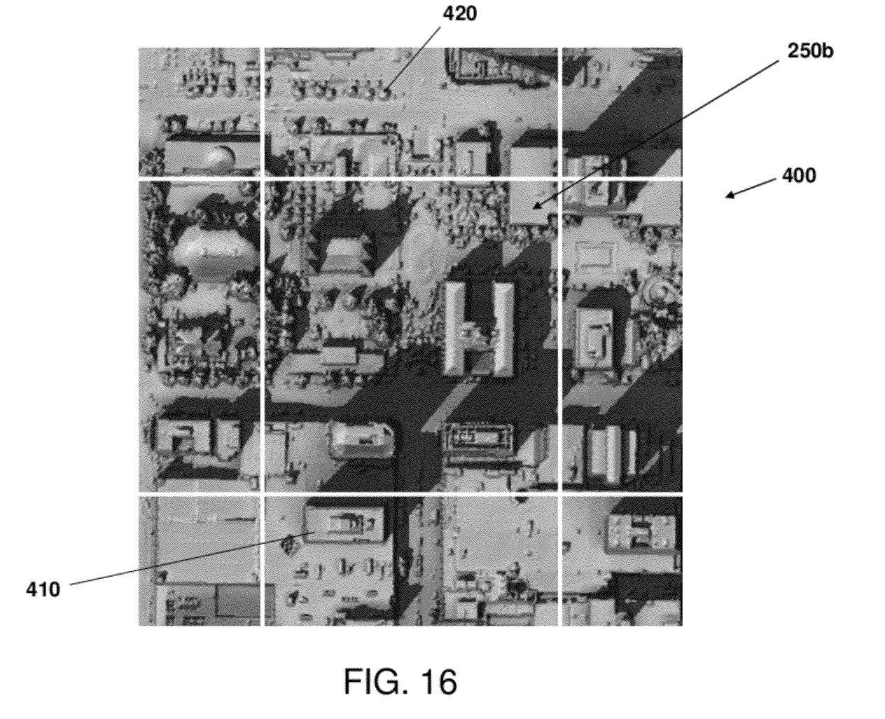

Turning now to FIGS. 15 and 16, an example of a dataset with shadow-mapping at a time of day is shown. The processing tile 400 given to the solar computational module may be used to calculate solar energy available over a specific time frame. Seasonal variances, such as sun angle, may also be accounted for. In FIGS. 15 and 16, the shadow calculations have been overlaid on a map to show the importance of the buffering principle. For instance, building 410 may have significant influence in buffered tile 250b. However, tree 420 may not have any effect on buffered tile 250b.

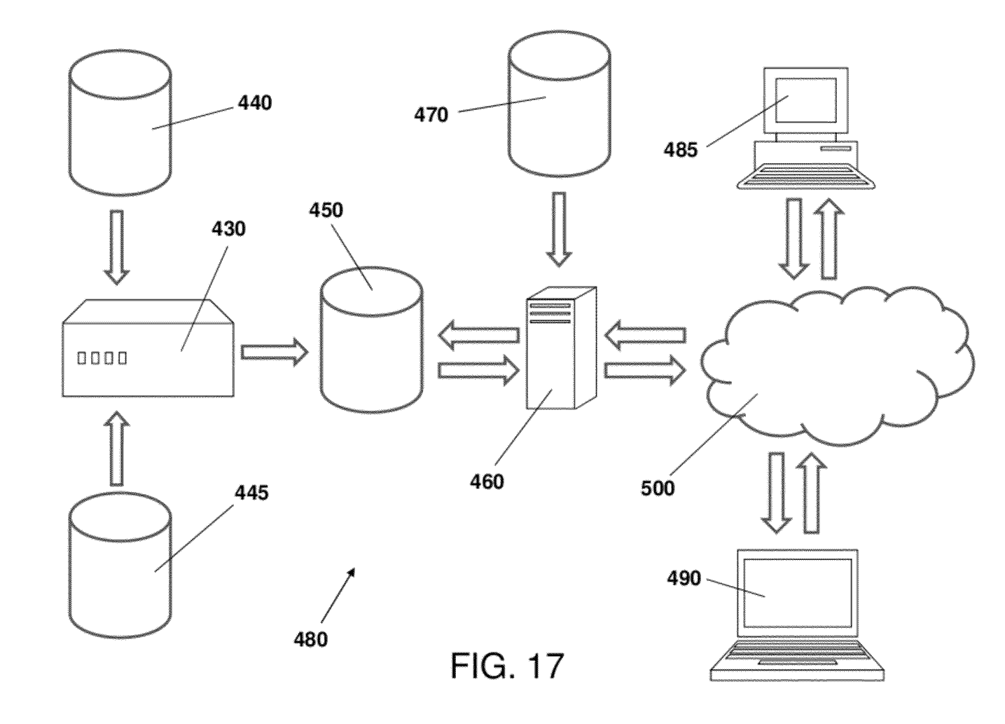

In FIGS. 17 to 19, the system is shown to produce a solar output dataset that may then be used in various derivative dataset construction operations. These derivative datasets may include solar heat maps, solar panel advice, heat island effect analysis, or other static or dynamic constructions and combination of datasets.

Turning now to FIG. 17, an example of a system 480 providing derivative mapping and advice based in the solar energy mapping is shown. A solar energy processing server 430 receives data from multiple databases 440, 445, which may include mapping data, atmospheric data, and solar data. The solar energy processing server 430 may process the data and return a solar output of the geographic area. In one embodiment, the solar energy processing server 430 outputs a solar output which includes an array of duration of solar energy and watt-hour of solar energy, where each element of the array represents one square meter of the geography.

The solar output may then be stored in a solar database 450 for retrieval by an application server 460. The application server 460 may then create derivative information from the solar database 450. This derivative information may include a solar heat map, available solar energy map, advice on solar panel placement, advice/predictions on plant/structure placement for influence on the reduction of heat to a building, or other solar energy maps, advice or transformations of the output.

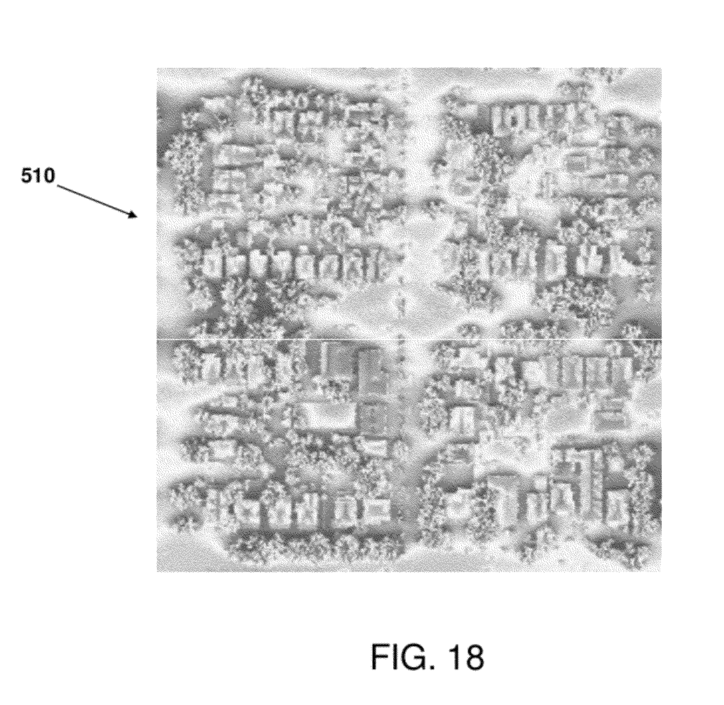

In one embodiment, the application server 460 retrieves a map from storage 470 to use in a solar heat map overlay 510 (shown in FIG. 18) created with the solar database 450. The system 480 may further estimate changes in the solar heat map if a tree or structure is placed in the map. Thus an architect or landscape artist can use the system to estimate the heat reduction to a building by using different plants or structures. Alternatively, a person may determine where to best locate solar panels. A person may also best determine where to place accumulations of snow when clearing snow to allow the snow to melt. It can be seen how there are many end uses to the solar analysis.

Furthermore, the system 480 may limit itself to specific portions of the solar database 450, such as times of the year. For instance, an architect may only be concerned about heat dissipation in the spring and summer months. Thus placement of plant or structures on the solar heat map may be limited to only reflect summer months.

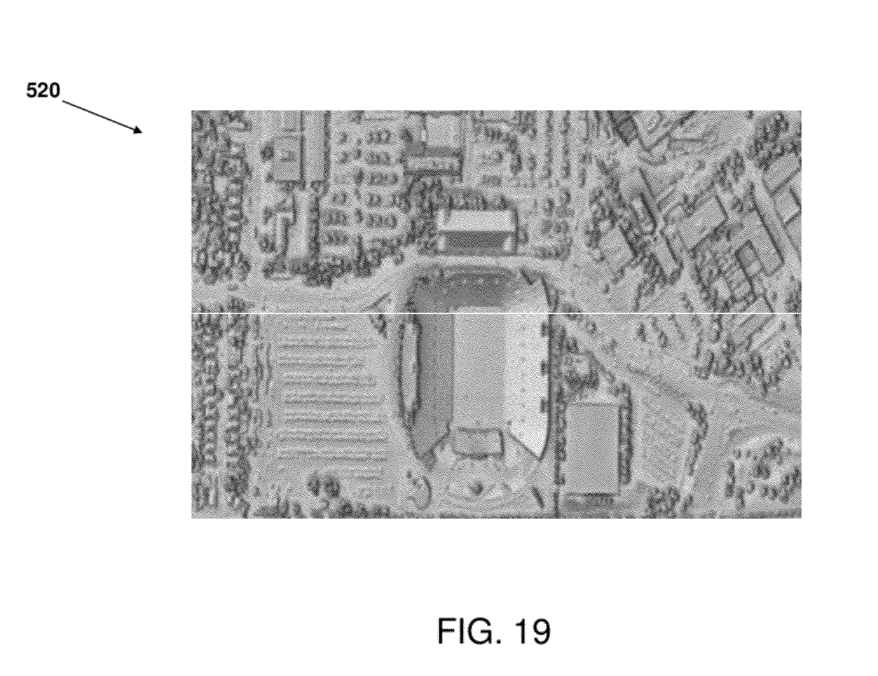

In another embodiment, the application server 460 retrieves a map from storage 470 to use in a solar energy map overlay 520 (shown in FIG. 19, an example of available solar energy upon a stadium in Salt Lake City) created with the solar database 450. A client computer 485 or mobile device 490, may access the application server 460 through a network 500, such as the internet. The client computer 485 may identify an area, such as a roof, and request the application server 480 to identify the amount of energy available to solar panels. The system 480 may also identify areas that would return a sufficient investment in the panels to warrant their placement.

In one embodiment, a web service (e.g., available in conjunction with the application server 460) may display data and advice based on the calculated solar energy. A user may visit the web service, search for their home or business and then select the desired area, such as a roof. The web service may give solar advice based on the selected roof size, useable roof percent and/or estimated system size. The web service may also show a comparison of system sizes. The system 480 may automatically calculate the square footage of the selected roof, amount of electricity generated, cost savings and carbon dioxide savings. In another window, the web service may also graph the expected solar duration or energy generation over time. The web service may also show results of a suggested system size, including benefits.

While the system has been described in terms of arrays, tiles, databases, servers and modules, it should be recognized that alterations to the structure may be obvious and anticipated. For instance, while the term database has been used, it is anticipated that other forms of data storage may be used, such as files, optical or magnetic media, cloud storage, database server or other forms of containing data, recalling data and data structures. While individual servers have been discussed for clarity, in some cases multiple servers may be used to perform the same task to increase performance. Similarly, a single server may also be used to perform multiple tasks. While module delineations have been discussed for clarity, it may be advantageous to join, split or reassign individual module task assignments. In fact, with multiple core computing, many tasks may be run in parallel, even though the task may appear linear in the description here. For example, the pre-processing step on a tile may be run in parallel with another tile that has been pre-processed and currently undergoing solar analysis.

There is thus disclosed an improved solar energy computation and advising system. It will be appreciated that numerous changes may be made to the present invention without departing from the scope of the claims.

What is claimed is:

1. A method of determining solar energy comprising:
receiving a set of geographic data from a database stored on an electronic data storage device, wherein the geographic data represents terrain features with corresponding heights;
invoking a processor to perform operations on the set of geographic data, wherein the operations comprise:
dividing the set into individual tiles, wherein each tile represents a unique geographic subset of the geographic data;
selecting a working tile from the individual tiles;
identifying a largest height value of the terrain features of neighboring tiles relative to the working tile; and
determining a buffer distance for the working tile based on the largest height value in the neighboring tiles.

2. The method of claim 1, further comprising calculating a height value for the working tile based on a height value of the terrain features within the working tile and the largest height value in the neighboring tiles.

3. The method of claim 1, wherein calculating the height value for the working tile further comprises:
determining that a largest height value of the terrain features of the working tile is greater than the largest height value of the neighboring tiles; and
selecting the largest height value of the working tile as the calculated height value of the working tile.

4. The method of claim 1, wherein calculating the height value for the working tile further comprises:
determining that the largest height value of the neighboring tiles is greater than a largest height value of the terrain features of the working tile; and
selecting the largest height value of the neighboring tiles as the calculated height value of the working tile.

5. The method of claim 1, wherein calculating the height value for the working tile further comprises selecting an average value from at least a portion of the height values of the working tile and the neighboring tiles.

6. The method of claim 5, wherein calculating the height value for the working tile further comprises selecting a mean value from the height values of the working tile and the neighboring tiles.

7. The method of claim 5, wherein calculating the height value for the working tile further comprises eliminating an outlier data point from the height values prior to selecting the average value.

8. The method of claim 1, wherein dividing the set into individual tiles further comprises establishing a tile size for each individual tile based on the heights of the terrain features within each individual tile.

9. The method of claim 1, wherein calculating the height value for the working tile further comprises eliminating an outlier data point from the height values prior to selecting the average value.

10. The method of claim 1, wherein determining the buffer distance for the working tile further comprises determining a substantially uniform buffer distance around the working tile.

11. The method of claim 1, wherein determining the buffer distance for the working tile further comprises determining a non-uniform buffer distance around the working tile.

12. The method of claim 1, wherein determining the buffer distance at least partially depends on a seasonal characteristic of at least one of the terrain features.

13. A solar advising system comprising:
a solar energy processing server, wherein the solar energy processing service comprises a processor configured to divide a set of geographic data into tiles, determine a buffer distance for each tile based on a largest z-value in neighboring tiles, compute solar energy for each tile, and combine the resulting solar energy for each tile back into an output dataset.

14. The system of claim 13, further comprising a geographic database coupled to the solar energy processing server, wherein the geographic database is configured to store the set of geographic data and to provide the set of geographic data to the solar energy processing server.

15. The system of claim 14, further comprising a solar database coupled to the solar energy processing server, wherein the solar database is configured to store the output dataset from the solar energy processing server.

16. The system of claim 15, further comprising an application server connected to the solar database, wherein the application server comprises a processor to combine the output dataset from the solar database with other data from a second database in preparation for presentation of the combined data to a client.

17. A solar processing system comprising:
a tiling module configured to process a set of geographic data into tiles, wherein the geographic data represents heights of terrain features;
a buffering module coupled to the tiling module, wherein the buffering module is configured to determine a buffer zone for each tile based on height values in neighboring tiles;
a solar computational module coupled to the buffering module, wherein the solar computation module is configured to output solar energy data within each tile based on the height values of the buffer zone and the height values within the tile itself; and
a database coupled to the solar computation module, wherein the database is configured to store the solar energy data for each tile.

18. The system of claim 17, further comprising a geographic database coupled to the tiling module, wherein the geographic database is configured to store the set of geographic data, and the set of geographic data comprises height values for corresponding terrain features.

19. The system of claim 17, wherein the database is further configured to store a correlation between the solar energy data for each tile and original information from the set of geographic data.

20. The system of claim 17, wherein the database is further configured to store a correlation between the solar energy data for each tile and a geographic map corresponding to a location represented by the set of geographic data.
